(19) United States
(12) Patent Application Publication
(10) Pub. No.: US 2003/0074308 A1
(43) Pub. Date: Apr. 17, 2003

(54) System and method for optimizing collection from skip accounts

(76) Inventors: Brian Michael Lawton, Richmond, VA (US); Michael Christopher Hild, San Francisco, CA (US); Ryan Conley Hunter, Washington, DC (US)

Correspondence Address: BAKER & MCKENZIE, 805 THIRD AVENUE, NEW YORK, NY, 10022, US

(21) Appl. No.: 09/976,205

(22) Filed: Oct. 12, 2001

(51) Int. Cl. G06F 17/60

(52) U.S. Cl. 705/38; 705/34

(57) ABSTRACT

A system for optimizing collection of outstanding balances of skip accounts is provided. The system includes a predictive model associated with an account tracing entity. The model processes data of a skip account to generate an output that indicates an expected recovery amount from the skip account. An analysis program determines a course of action based on the output of the predictive model. In one embodiment, the system includes a different predictive model for each tracing entity. The predictive models are applied to the skip account data to determine the expected recovery amounts for all tracing entities. The skip account is then sent to the tracing entity associated with the highest expected recovery amount as the optimal course of action to take.

### FIELD OF THE INVENTION

The present invention relates to data processing systems, and in particular, to systems that optimize collection of accounts receivables by using predictive models.

### BACKGROUND OF THE INVENTION

A financial institution such as a credit card issuer loses millions of dollars from uncollectable accounts of card users. In many cases, card users simply “skip town” and disappear, making them difficult to locate. An account is called a skip account if there is no valid contact information of the account holder such as a telephone number.

One traditional industry approach to collect on skip accounts is to send them to a skip account tracer (database vendor) such as LEXIS-NEXIS or Equifax to obtain contact information in an attempt to locate the accounts. Generally, the tracers return telephone numbers of the account holders. The skip accounts with telephone numbers are then given to collection agents to be worked with the assumption that the obtained telephone numbers are valid.

One problem with this approach is that the numbers obtained are often incorrect. Moreover, even if the numbers are correct, the card holders often refuse to pay. These factors substantially drive up the cost of collecting from the skip accounts. Some card issuers give up even trying to locate the accounts and simply turn them over to a collection agency.

Therefore, there is a need for an improved system and method for optimizing collection of outstanding balances from the skip accounts.

### SUMMARY OF THE INVENTION

According to the present invention, a system for optimizing collection of money from skip accounts is provided. The system includes a processor operable to execute programs instructions and a memory coupled to the processor. A predictive model stored in the memory is associated with an account tracing entity. The model processes data of a skip account to generate an output that indicates an expected recovery amount from the skip account. An analysis program stored in the memory determines a course of action based on the output of the predictive model.

In one embodiment, the system includes a different predictive model for each tracing entity. The predictive models are applied to the skip account data to determine the expected recovery amounts for all tracing entities. The skip account is then sent to the tracing entity associated with the highest expected recovery amount as the optimal course of action to take. As can be appreciated, the system maximizes the expected recovery amount from skip accounts by evaluating the potential for recovery from using different tracing entities.

### BRIEF DESCRIPTION OF THE DRAWINGS

FIG. 1 is a block diagram of one implementation of a system in accordance with the present invention.

FIG. 2 is a block diagram showing a functional architecture of the present invention.

FIG. 3 is a flow chart of a method of analyzing a skip account for optimal collection according to the present invention.

FIG. 4 is an exemplary predictive model using a set of equations to analyze the skip account according to the present invention.

FIG. 5 is an exemplary predictive model related to the likelihood of locating a skip account through a selected tracing entity according to the present invention.

FIG. 6 is an exemplary predictive model related to the liquidation rate of a skip account according to the present invention.

FIG. 7 is an exemplary list of variables that may be used to develop the predictive models according to the present invention.

FIG. 8 is an exemplary table illustrating degradation factors.

### DETAILED DESCRIPTION OF THE INVENTION

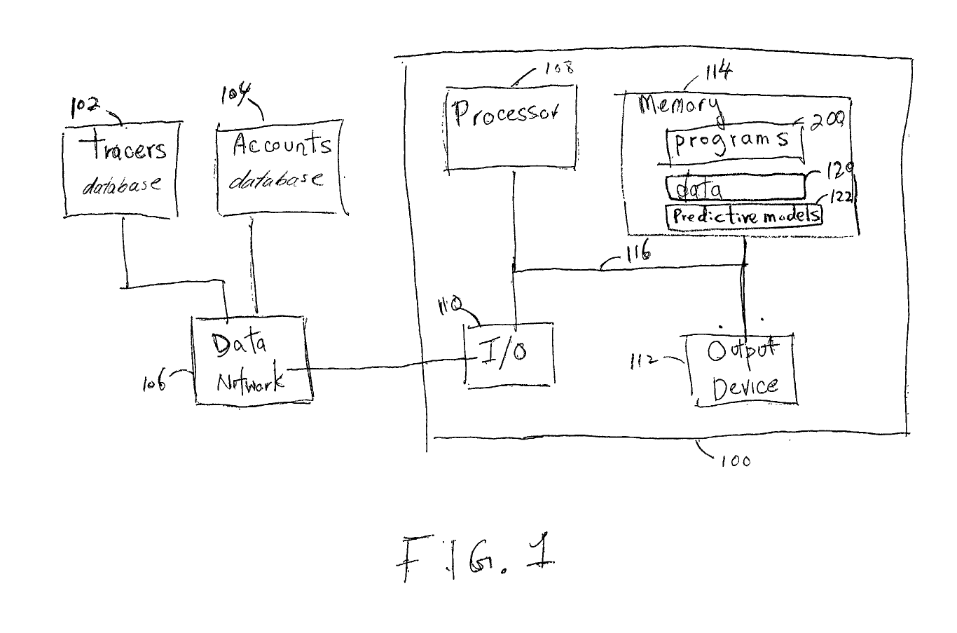

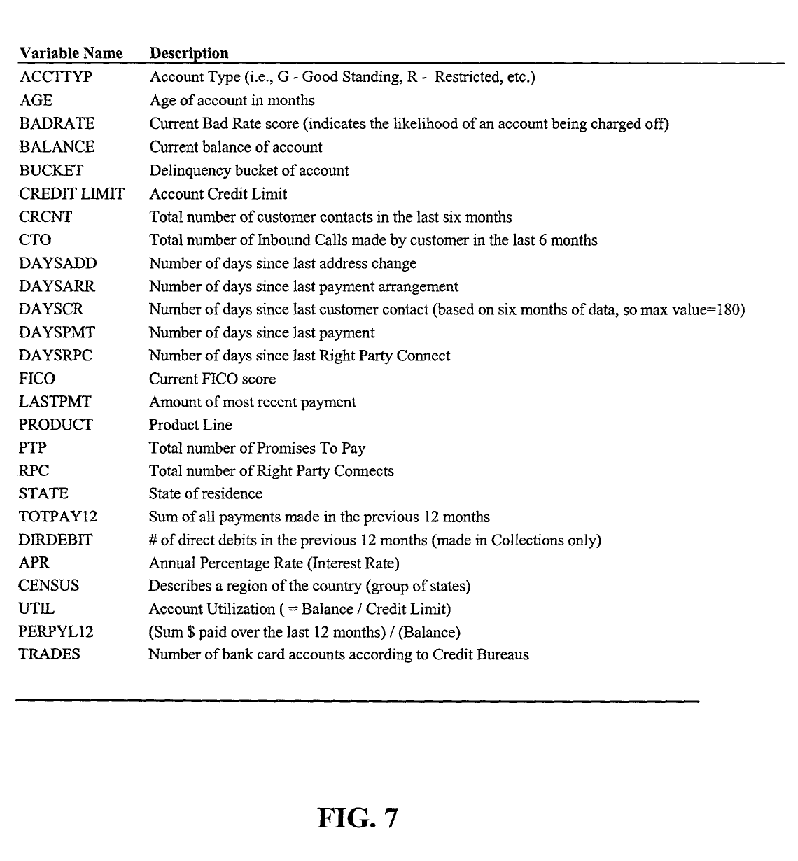

FIG. 1 shows a block diagram of one implementation of a system 100 in accordance with the present invention. Tracers database 102 and accounts database 104 are connected to the system 100 through a conventional data network 106. The data network can be a public network such as the Internet or a private network. The accounts database 104 stores such customer data as customer profiles and past transactions as shown in FIG. 7. The tracers database 102 stores information related to the past success or failure of locating skip accounts for various account tracing entities (also known as “tools”) which are generally database vendors, private investigators or CM (continuous monitoring) tools. It should be understood that data as used herein means either a single data element or multiple data elements.

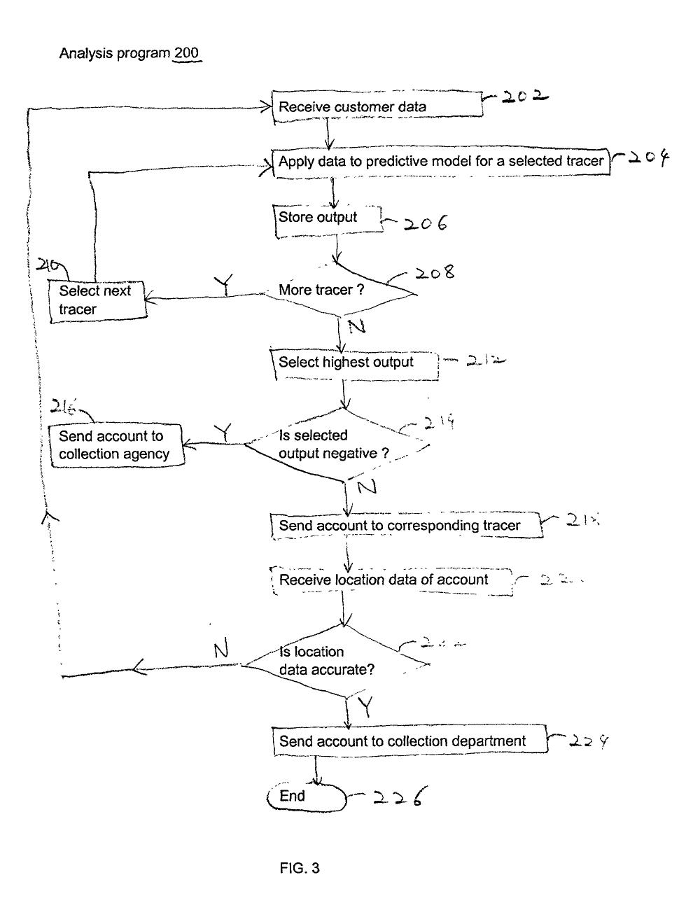

The system 100 includes a processor 108, I/O interface 110 connected to the data network 106, output device 112 and memory 114 which are all connected to each other through a common bus 116. The processor 108 runs software program instructions stored in the memory 114. The memory 114 contains programs such as an analysis program 200 of FIG. 3, temporary data 120 and predictive models 122 that have been developed for the tracing entities. According to the software program instructions, the processor 108 stores the data obtained from the data network 106 in the temporary data 120. The processor 108, temporary data 120, programs 200 and predictive models 122 operate together to generate an output to the output device 112. The generated output is indicative of an expected recovery amount from the skip account from using a particular tracing entity to locate the account. In a preferred embodiment, a predictive model is developed for each tracing entity and the outputs of all predictive models are compared against each other to determine an optimal course of action as will be explained in detail later herein.

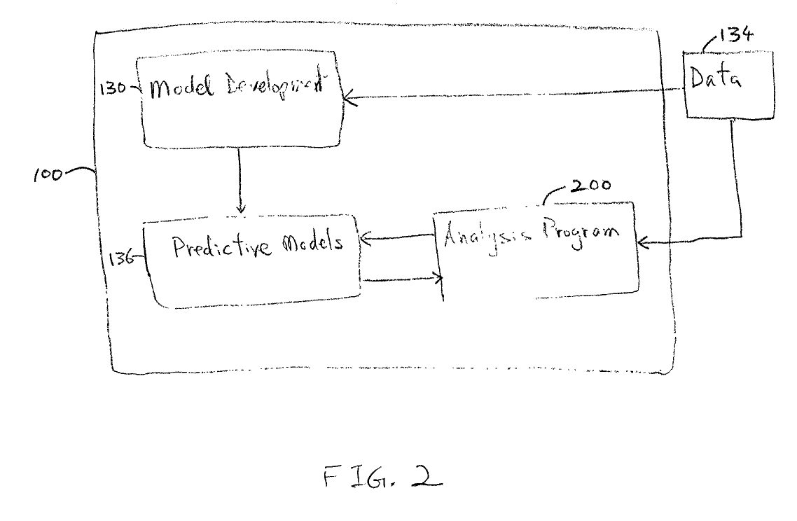

Referring now to FIG. 2, an overall functional architecture of the system 100 is shown. The system 100 includes two components: model development component 130 and model processing component (analysis program) 200. The model development component 130 uses past data 134 stored in the tracers and accounts databases 102, 104 to build a predictive model 136 for each tracing entity. In one embodiment, there are twelve different tracing entities. Thus, twelve predictive models are developed by the model development component 130. Although a regression based predictive model is used in the embodiment shown, any type of predictive modeling technique such as neural network modeling may be used.

The analysis program component 200 receives data 134 of a skip account being evaluated and applies the predictive model 136 against the data. The output of the analysis program 200 is evaluated to determine a proper course of action to take as will be explained later in more detail with reference to FIG. 3.

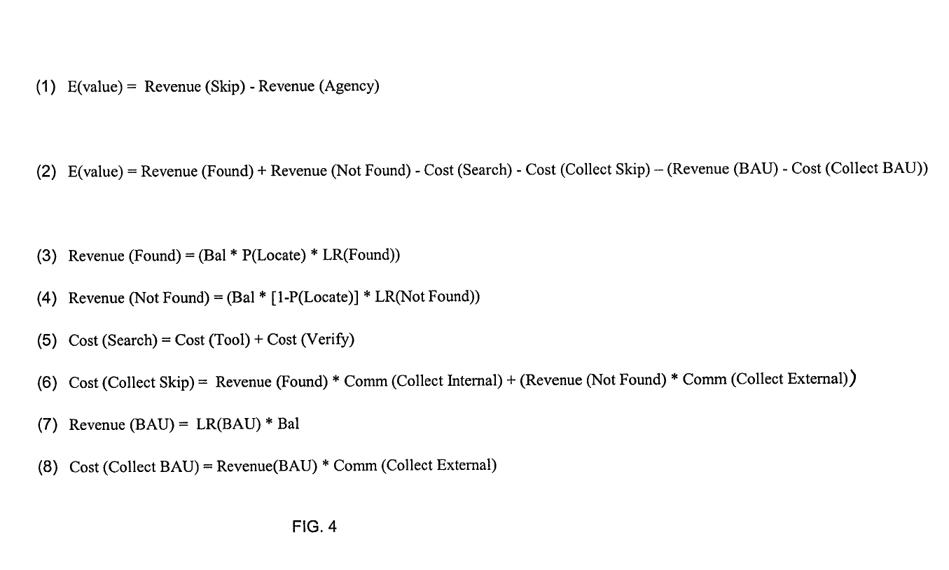

An exemplary predictive model is shown in FIG. 4. The predictive model in FIG. 4 includes four models: P(Locate), LR(Found), LR(Not Found) and LR(BAU). The P(Locate) model predicts a percentage likelihood of finding a skip account using a corresponding tracing entity. The LR(Found) model predicts a net liquidation rate if a search is done and the account (account user) is found. The liquidation rate is preferably in a range of 0 to 1. The liquidation rate, however, can be less than 0 or greater than 1. The LR(Not Found) model predicts a net liquidation rate if a search is done, but the account is not found. In an exemplary embodiment, if the account is not found, the predicted net liquidation rate may change since data associated with the account is updated before rerunning the data through the respective model. In an alternative embodiment, the LR(Found) model and the LR(Not Found) model are changed if another search is done using a different tracing entity. The LR(BAU) model predicts a net liquidation rate if no search is performed and the skip account is instead sent to a collection agency. These four models will be explained in detail later herein.

As shown in equation (1) of FIG. 4, the predictive model's output value E(value) is equal to Revenue (Skip) minus Revenue (Agency) where Revenue (Skip) represents a net revenue expected to be collected from a skip account if a corresponding account tracing entity is used to locate the account, and Revenue (Agency) represents a net revenue expected to be collected from the skip account if no search is performed to locate the account and it is instead sent to a collection agency.

Equations (2) and (3) through (8) show more detailed breakdowns of equation (1). In equation (2), Revenue (Found) represents a revenue amount expected to be collected if the account tracing entity correctly locates the skip account. It is determined by multiplying the balance or accounts receivable Bal, output of the P(Locate) model, and output of the LR(Found) model together as shown in equation (3). For example, if $500 balance is owed on the skip account, there is a 30% chance that the corresponding tracing entity can locate the account, and the liquidation rate if found is 50%, then the Revenue (Found) is $75.

Revenue (Not Found) represents a revenue amount expected to be collected if the account tracing entity fails to locate the current skip account. The amount is usually greater than zero since many skip accounts do pay at least a portion of the balance on the account even if no special effort is made to collect on the account. Revenue (Not Found) is determined by multiplying the balance Bal, output of (1- P(Locate)) which is a percentage likelihood of failing to locate the skip account through the tracing entity, and LR(Not Found) together as shown in equation (4). Continuing with the same example, if LR(Not Found) is 10%, then Revenue (Not Found) is $35.

Cost (Search) represents a cost of locating the skip account through the account tracing entity. It is determined by Cost (Tool) plus Cost (Verify) as shown in equation (5). Cost (Tool) represents the amount the tracing entity charges which is usually a fixed fee per account. If the tracing entity is a private investigator, however, payment is made only for successfully located accounts. Thus, the cost of the tool is the fee charged multiplied by the percentage probability of success P(Locate). Cost (Verify) represents the cost of verifying the accuracy of the locate information derived from the tracing entity. Typically, the locate information received from the tracing entity includes a telephone number of the account holder. In that case, the cost of verification is the cost associated with calling the number. With the same example above, if the tracing entity used charges $1 for each locate and it costs $2.50 to verify, Cost (Search) is $3.50.

Cost (Collect Skip) represents a cost of collecting from the skip account after the account is sent to a tracing entity, but regardless of whether the account is accurately located or not. As shown in equation (6), it is determined by Revenue (Found) times Comm (Collect Internal), which is an internal cost of collection, plus Revenue (Not Found) times Comm (Collect External), which is an external cost of collection. Comm (Collect Internal) represents the card issuer's internal commission rate of collection. In one embodiment, the commission is a fixed percentage of amount collected. Comm (Collect External) represents the issuer's external commission rate of collection if it were to outsource the account to a collection agency after having failed to locate the account through the tracing entity. Continuing with the same example above, if the internal and external commission rates are 12%, Cost (Collect Skip) is $9 plus $4.20 which is a total of $13.20.

Revenue (BAU), where BAU stands for business as usual, represents a revenue amount expected to be collected if the account is sent to a collection agency with no action being taken to locate the account through the account tracing entity. As shown in equation (7), it is determined by multiplying the output of the LR(BAU) model by the balance on the account. Continuing with the same example above, if LR(BAU) outputs 0.2 (20%), then Revenue(BAU) is $100.

Cost (Collect BAU) represents a cost of collecting from the skip account if the account is sent to a collection agency with no action being taken to locate the account through the account tracing entity. As shown in equation (8), it is determined by multiplying Revenue (BAU) by Comm (Collect External). Continuing with the same example above, Cost (Collect BAU) is $12.

The example used above yields a final E(value) of $5.30. This means that it is more efficient to send the skip account to a tracing entity rather than send the skip account to a collection agency as will be discussed in more detail with reference to FIG. 3.

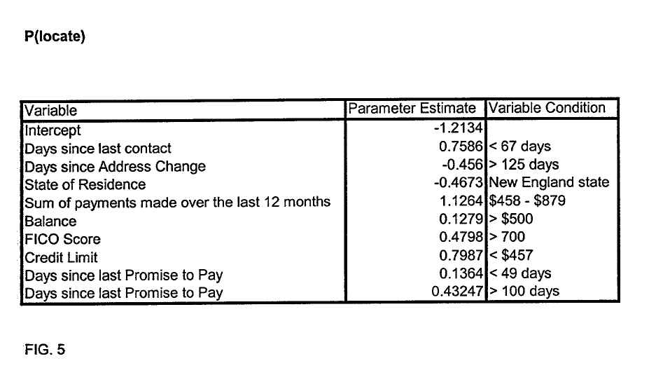

Referring now to FIG. 5, an example P(Locate) model for one tracing entity is illustrated. In the embodiment shown, the P(Locate) models are logistic regression models. These models are used because the input variables are both continuous and discrete and the desired output is discrete. As is well-known, these types of models are fed a specific data set, which is used to predict the percent likelihood of a given event occurring. The result of the model is given in the form of a percentage, between 0 and 1.

As discussed earlier, the P(Locate) model predicts a percentage probability of locating a given account using a given tracing entity. Knowing whether one tracing entity is, for example, 2% or 56% likely to find an account is important information in determining whether it is efficient to send a skip account to that tracing entity.

To develop the P(Locate) model for each tracing entity, accounts data sets involving variables such as shown in FIG. 7 and the tracers data are processed. In the embodiment shown, one P(locate) model is developed for one corresponding tracing entity. By separating the models among the different tracing entities, each model uses only the data elements which are relevant to it, and it can weight each piece of information differently. Also, different P(Locate) models can “bin” information differently. For example, while two models may both use the FICO score to predict location, one model may attribute negative probability to accounts whose FICO score is less than 500 and the other model may attribute positive probability to accounts whose FICO score is greater than 550. Other models may use different balance cuts. As can be appreciated by persons skilled in the art, the use of separate models for different tracing entities provides a much more accurate prediction.

Still referring to FIG. 5, the P(Locate) model has 3 columns. The first column contains the variable names, the third column contains the variable conditions, and the second column contains the parameter values to be added if the variable conditions are “true”. The Intercept is always added to the model output calculation. The output is then determined by the following logistic regression equation (9).

P(Locate)=1/(1+e^{-X}) (9)

where x represents the addition of the Intercept and all other parameters whose corresponding variable conditions are “true”.

For example, for a particular skip account, if the Days Since Address Change is greater than 125 days, the State of Residence is a New England State, and Balance was greater than $500, then the addition of the intercept and all other parameters for true conditions is −2.0088 and P(Locate) is determined to be 0.118. That means there is an 11.8% likelihood that the account will be located by the corresponding tracing entity.

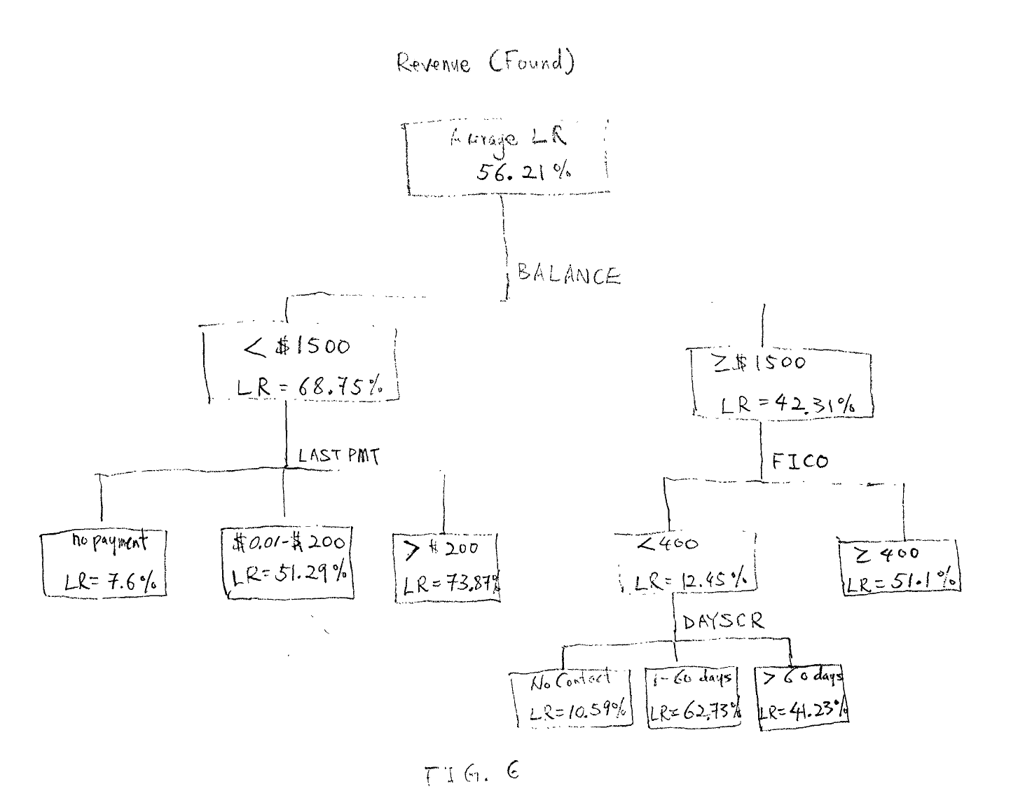

Referring to FIG. 6, an example Revenue (Found) model is illustrated. In the embodiment shown, the model is based on CHAID (Chi-square Automatic Interaction Detection). The Revenue (Found) model predicts a net liquidation rate of an account over time if a search is done and the account is found. In one embodiment, the rate is determined by the sum of (payments made −(purchases+cash advances+balance transfers)) divided by the balance on the account at the time the model processes the account.

To develop the Revenue (Found) model, an accounts data set stored in accounts database 104 involves variables such as shown in FIG. 7. Alternatively, tracers data stored in tracers database 102 can also be used with the accounts data. In the embodiment shown, one Revenue (Found) model is developed for use by all corresponding tracing entities in the formula E(value) in FIG. 4.

The Revenue (Found) CHAID model generally works as decision trees. Each branch of the tree represents a different condition (for example, if the balance is greater than or less than $500). At each decision point, there is an expected LR. Also, at the end of each branch there are “nodes” which list an expected LR. An account that meets the conditions of the particular node would have that expected LR. The nodes are mutually exclusive and collectively exhaustive. If for some reason some accounts do not have the data element available, the LR at the last node for which all of the needed information is available is used.

Still referring to FIG. 6, if the balance on the skip account is greater than $1,500 and the FICO score is greater than or equal to 400, then the output of the Revenue (Found) model is 0.511 or 51.1%.

The Revenue (Not Found) and Revenue (BAU) models are also CHAID models that are developed in a similar manner as the Revenue (Found) model.

Once all of the predictive models 136 are developed, they are stored in the memory 114 at 122 for fast access by the analysis program 200. Referring to FIG. 3, the program in step 202 receives the customer data stored in database 104 including customer profile data such as ACCTTYP, CREDIT LIMIT and STATE (see FIG. 7 for definition), and transaction data such as BALANCE, LASTPMT and TOTPAY12. In step 204, the program 200 applies the received data to the predictive model associated with a selected tracing entity to generate an output E(value). The output E(value) represents an expected recovery amount from the skip account being processed. The output is then stored in the memory 114 at 120 in step 206. Alternatively, the output can be sent to the output device 112.

In step 208, it is determined whether there are more tracing entities to process. If YES, control passes to step 210 where the next tracing entity is selected and steps 204 and 206 are repeated for each tracing entity. If the decision at 208 is NO, then there are no more tracing entities to process and the program 200 continues with step 212. At 212, the program evaluates all outputs of the predictive models and selects the highest output.

In step 214, it is determined whether the selected output is negative, meaning that the expected recovery amount is negative even from using the best tracing entity for the particular skip account being processed. If YES, then control passes to step 216 where the account is sent to a collection agency as the proper course of action to take. If the decision is NO, then the program continues with step 218 where the skip account is sent to the tracing entity associated with the highest output in order to locate the account. In step 220, the location data, typically including a telephone number of the account holder, is received from the tracing entity for verification.

In step 222, it is determined whether the location data returned is accurate. This step typically involves calling the telephone number to verify that the number belongs to the proper account holder. If the location data is determined to be inaccurate, control passes to step 202 where the entire decisioning process (steps 202 through 222) is repeated for the remaining tracing entities. Before the redecisioning, the P(Locate) is adjusted to take into account that the “best” tracing entity failed to locate the account. The customer data stored at the database 104 are received again because a significant amount of time may have passed between the previous decisioning process and the next, and many of the data may have changed during that time.

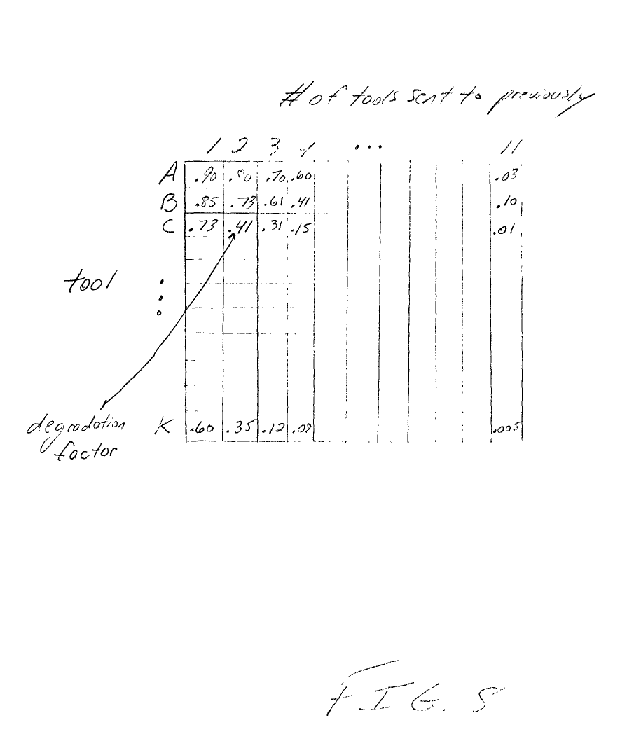

In an exemplary embodiment, P(Locate) is adjusted in the following way. A P(Locate) is calculated using updated data by the same P(Locate) model described above. Next, the P(Locate) is multiplied by a degradation factor. The degradation factor is determined, for example, during past testing for each vendor. The degradation factor estimates the reduction in P(Locate) for each tool, given that 1, 2, 3, 4 . . . or 11 tools have attempted to locate an account, but failed. If more tools are added, then the values of the degradation factors would have to be recalculated. The degradation factors are stored in a table, for example, a 11×11 table, which the models use to look up the appropriate values, as shown in FIG. 8. The degradation factors illustrated in FIG. 8 are merely exemplary. For example, if an account was run through a P(Locate) model of tool C and received a value of 0.35 and the account had already been sent unsuccessfully to tools A and B, then the number of tools sent to previously would be two. Thus, referring to the table shown in FIG. 8, the 0.35 P(Locate) value would be adjusted by multiplying the value by the 0.41 degradation factor since tool C was used and the account had already been sent to two tools. The final P(Locate) would be 0.35×0.41 which equals 0.1435.

If the location data is determined to be accurate in step 222, then control passes to step 224 where the account is sent to the card issuer's internal collection department for collection. In one embodiment, an account verifier calls the telephone number obtained from the tracing entity. If the number is verified to be accurate, the call is transferred to an internal collection agent to be worked. The program then ends at step 226.

From the foregoing, it will be appreciated that, although specific embodiments of the invention have been described herein for purposes of illustration, various modifications may be made without deviating from the spirit and scope of the invention. For example, although the illustrated predictive model includes four different models, the present invention can operate with one or more models such as a system based only on the probability model outputting a likelihood of locating a skip account by a tracing entity. In that case, the skip account will be sent to the tracing entity associated with the highest probability. Accordingly, the present invention is not limited except as by the appended claims.

What is claimed is:

1. A method for optimizing collection of money from skip accounts, comprising:
receiving data of a first skip account;
applying the data of the first skip account to a predictive model, the predictive model being associated with an account tracing entity and operable to generate an output indicative of an expected recovery amount from the first skip account; and
determining a course of action based on the output from application of the predictive model.

2. The method according to claim 1, wherein the predictive model includes a probability model that generates an output indicative of the likelihood of locating the first skip account from the account tracing entity.

3. The method according to claim 2, wherein the output of the probability model is reduced according to a number of other account tracing entities which previously failed to locate the first skip account.

4. The method according to claim 3, wherein the reduced output equals the output of the probability model times a degradation factor.

5. The method according to claim 2, wherein the predictive model further includes:
a first liquidation model that generates an output indicative of an expected recovery amount from the first skip account if the account tracing entity correctly locates the first skip account; and
a second liquidation model that generates an output indicative of an expected recovery amount from the first skip account if the account tracing entity fails to locate the first skip account.

6. The method according to claim 2, wherein the predictive model further includes:
a third liquidation model that generates an output indicative of an expected recovery amount from the first skip account if no action is taken to locate the first skip account through the account tracing entity.

7. The method according to claim 2, wherein the probability model is derived by performing a regression analysis on past data of a plurality of skip accounts and the success or failure of locating the plurality of skip accounts by the account tracing entity.

8. The method according to claim 5, wherein the first and second liquidation models are CHAID models that are derived from an analysis of past data of a plurality of skip accounts and the success or failure of locating the plurality of skip accounts by the account tracing entity.

9. The method according to claim 1, wherein the predictive model includes:
a probability model that generates an output indicative of the likelihood of locating the first skip account from the account tracing entity;
a first liquidation model that generates an output indicative of an expected recovery amount from the first skip account if the account tracing entity correctly locates the first skip account;
a second liquidation model that generates an output indicative of an expected recovery amount from the first skip account if the account tracing entity fails to locate the first skip account; and
a third liquidation model that generates an output indicative of an expected recovery amount from the first skip account if no action is taken to locate the first skip account through the account tracing entity.

10. The method according to claim 1, wherein the output of the predictive model represents:
Revenue (Skip)−Revenue (BAU),
wherein Revenue (Skip) represents a net revenue expected to be collected from the first skip account if the account tracing entity is used to locate the account, and
Revenue (BAU) represents a net revenue expected to be collected from the first skip account if no action is taken to locate the first skip account through the account tracing entity.

11. The method according to claim 10, wherein
Revenue (Skip) is of the form:
Revenue (Found)+Revenue (Not Found)−Cost (Search) −Cost (Collect Skip),
wherein
Revenue (Found) represents a revenue amount expected to be collected if the account tracing entity correctly locates the first skip account,
Revenue (Not Found) represents a revenue amount expected to be collected if the account tracing entity fails to locate the first skip account,
Cost (Search) represents a cost of locating the first skip account through the account tracing entity, Cost (Collect Skip) represents a cost of collecting from the first skip account, and
Revenue (BAU) is of the form:
Revenue (BAU)−Cost (Collect BAU),
wherein
Revenue (BAU) represents a revenue amount expected to be collected if no action is taken to locate the first skip account through the account tracing entity, and Cost (Collect BAU) represents a cost of collecting from the first skip account if no action is taken to locate the first skip account through the account tracing entity.

12. The method according to claim 1, wherein the step of determining a course of action includes determining that the first skip account is to be sent to a collection agency if the output of the predictive model indicates that the expected recovery amount from the first skip account is negative.

13. The method according to claim 1, wherein:
the predictive model is derived from an analysis of past data of a plurality of skip accounts; and
the past data includes data related to one or more of the following variables: location, payment history, balance, FICO score and credit limit.

14. A method for optimizing collection of money from skip accounts, comprising:
obtaining past data related to a plurality of skip accounts and to the success or failure of locating the plurality of skip accounts by a plurality of account tracing entities;
processing the past data to derive a predictive model for each of the plurality of account tracing entities;
receiving data of a first skip account;
applying the data of the first skip account to the predictive models to generate a plurality of outputs, each output being associated with a corresponding account tracing entity and being indicative of an expected recovery amount by using a corresponding account tracing entity to locate the first skip account; and
determining a course of action based on the generated outputs of the predictive models.

15. The method according to claim 14, wherein the step of determining a course of action includes sending the first skip account to the account tracing entity whose corresponding predictive model output is the highest and positive.

16. The method according to claim 15, further comprising:
repeating the steps of receiving the data, applying the data and determining a course of action if the account tracing entity whose corresponding predictive model output is the highest and positive fails to locate the first skip account.

17. The method according to claim 14, wherein the step of determining a course of action includes sending the first skip account to a collection agency if each of the outputs is negative.

18. The method according to claim 14, wherein the predictive model for each account tracing entity includes a probability model that generates an output indicative of the likelihood of locating the first skip account from the each account tracing entity.

19. The method according to claim 14, wherein the predictive model for each account tracing entity further includes:
a first liquidation model that generates an output indicative of an expected recovery amount from the first skip account if the each account tracing entity correctly locates the first skip account; and
a second liquidation model that generates an output indicative of an expected recovery amount from the first skip account if the each account tracing entity fails to locate the first skip account.

20. The method according to claim 14, wherein the predictive model further includes:
a third liquidation model that generates an output indicative of an expected recovery amount from the first skip account if no action is taken to locate the first skip account through the each account tracing entity.

21. The method according to claim 15, wherein the predictive model is derived by performing a regression analysis on the past data.

22. The method according to claim 19, wherein the first and second liquidation models are CHAID models that are derived from an analysis of the past data.

23. The method according to claim 20, wherein the third liquidation model is a CHAID model that is derived from an analysis of the past data.

24. The method according to claim 14, wherein the predictive model for each skip tracing entity includes:
a probability model that generates an output indicative of the likelihood of locating the first skip account from the each account tracing entity;
a first liquidation model that generates an output indicative of an expected recovery amount from the first skip account if the each account tracing entity correctly locates the first skip account;
a second liquidation model that generates an output indicative of an expected recovery amount from the first skip account if the each account tracing entity fails to locate the first skip account; and
a third liquidation model that generates an output indicative of an expected recovery amount from the first skip account if no action is taken to locate the first skip account through the each account tracing entity.

25. A system for optimizing collection of money from skip accounts, comprising:
a processor operable to execute programs;
memory coupled to the processor;
a predictive model stored in the memory and associated with an account tracing entity, the predictive model being operable to process data of a first skip account to generate an output indicative of an expected recovery amount from the first skip account; and
an analysis program stored in the memory and executable by the processor, the analysis program being operable to determine a course of action based on the output of the predictive model.

26. The system according to claim 25, wherein the predictive model includes a probability model that generates an output indicative of the likelihood of locating the first skip account from the account tracing entity.

27. The system according to claim 26, wherein the predictive model further includes:
a first liquidation model that generates an output indicative of an expected recovery amount from the first skip account if the account tracing entity correctly locates the first skip account; and
a second liquidation model that generates an output indicative of an expected recovery amount from the first skip account if the account tracing entity fails to locate the first skip account.

28. The system according to claim 26, wherein the predictive model further includes:
a third liquidation model that generates an output indicative of an expected recovery amount from the first skip account if no action is taken to locate the first skip account through the account tracing entity.

29. The system according to claim 26, wherein the probability model is derived by performing a regression analysis on past data of a plurality of skip accounts and the success or failure of locating the plurality of skip accounts by the account tracing entity.

30. The system according to claim 27, wherein the first and second liquidation models are CHAID models that are derived from an analysis of past data of a plurality of skip accounts and the success or failure of locating the plurality of skip accounts by the account tracing entity.

31. The system according to claim 28, wherein the third liquidation model is a CHAID model that is derived from an analysis of past data.

32. A computer readable storage medium containing instructions for causing a computer system to optimize collection of money from skip accounts, by:
receiving data of a first skip account;
applying the data of the first skip account to a predictive model, the predictive model being associated with an account tracing entity and operable to generate an output indicative of an expected recovery amount from the first skip account; and
determining a course of action based on the output from application of the predictive model.

33. The computer readable medium according to claim 32, wherein the predictive model includes a probability model that generates an output indicative of the likelihood of locating the first skip account from the account tracing entity.

34. The computer readable medium according to claim 32, wherein the predictive model includes:
a probability model that generates an output indicative of the likelihood of locating the first skip account from the account tracing entity;
a first liquidation model that generates an output indicative of an expected recovery amount from the first skip account if the account tracing entity correctly locates the first skip account;
a second liquidation model that generates an output indicative of an expected recovery amount from the first skip account if the account tracing entity fails to locate the first skip account; and
a third liquidation model that generates an output indicative of an expected recovery amount from the first skip account if no action is taken to locate the first skip account through the account tracing entity.
